(19) United States
(12) Patent Application Publication
(10) Pub. No.: US 2022/0114682 A1
(43) Pub. Date: Apr. 14, 2022

(54) ONLINE SYSTEM AND METHOD FOR ONLINE RENTAL PROPERTY MANAGEMENT

(71) Applicant: Kenya Spells, Indianapolis, IN (US)

(72) Inventor: Kenya Spells, Indianapolis, IN (US)

(21) Appl. No.: 17/066,720

(22) Filed: Oct. 9, 2020

(51) Int. Cl. G06Q 50/16; G06Q 30/06; G06Q 40/02; G06Q 20/12; G06Q 30/08; G06Q 10/10; G06Q 20/08; G06Q 50/18; G06Q 50/26

(52) U.S. Cl. CPC G06Q 50/163; G06Q 30/0645; G06Q 40/025; G06Q 20/127; G06Q 50/265; G06Q 10/10; G06Q 20/085; G06Q 50/188; G06Q 30/08

(57) ABSTRACT

An online rental property management system includes hardware, software, applications, and data storage, with the data storage storing a prospective tenant profile, a rental property listing, and a landlord profile. The prospective tenant profile includes tenant personal information, a rental property description, a rental background check, income verification, and a credit check. The landlord profile also includes verified information. A subscription is selected by a prospective tenant and includes at least a payment of a predetermined fee corresponding to a number of different rental applications. The landlord may similarly select a subscription, which provides a predetermined number of approved or not approved prospects for review. The rental property description of the prospective tenant profile is compared to one or more rental property listings in the data storage, and system identifies selected rental property listings that at least partially match the rental property description of the prospective tenant profile. Based on the comparing and identifying steps, the system designates the prospective tenant as approved with respect to the selected rental property listings.

### BACKGROUND

This specification relates to the field of software. More specifically, the present technology is in the technical field of software-based online rental property management.

The disclosure describes a system and method for helping prospective tenants, or renters, and landlords match prospective tenants with rental properties. There is a large market for rental properties, such as apartments, houses, businesses, etc., and particularly so in large cities. However, prospective tenants traditionally have limited choice in locating rental properties, such as, for example: online advertisements and postings, newspapers, social media and seeing a for rent sign. Further, prospective tenants are often looking for an apartment or other rental property in an unfamiliar community and/or with limited resources, such as limited technological resources. Landlords also have issues with locating an ideal prospective tenant for a rental property.

Locating and/or applying for a rental property such as, for example, an apartment can take a long time. The rental process generally requires the completion of an application form and payment of a processing fee. The application form typically includes social security number, driver's license number, previous address of residence, employment information, monthly income, credit score, most recent paystubs, criminal background check, etc. Using this information, the landlord can assess whether or not the prospective tenant would be a good fit for the rental property. Unfortunately, however, prospective tenants and landlords typically have difficulty locating a mutually desirable match. If a match is not made, the process starts over again for both parties.

The present novel technology addresses these needs.

### SUMMARY

This specification relates to the field of software. More specifically, the present technology is in the technical field of software-based online rental property management.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an environment in which an online rental property management system may operate, according to an exemplary embodiment of the present disclosure.

FIG. 2 depicts an exemplary webpage, illustrating registration for and/or use of an exemplary embodiment of the online rental property management system by a prospective tenant and/or landlord, according to an aspect of the present disclosure.

FIG. 3 depicts a webpage illustrating entry of search criteria for locating particular rental properties, according to another aspect of the present disclosure.

FIG. 4 depicts a webpage illustrating selection of a subscription offered by the online rental property management system, according to another aspect of the present disclosure.

FIG. 5 depicts a webpage facilitating entry of a profile for a prospective tenant, according to an aspect of the present disclosure.

FIG. 6 depicts a webpage illustrating search results according to the exemplary online rental property management system.

FIG. 7 depicts an exemplary application form for a prospective tenant, according to an aspect of the present disclosure.

FIG. 8 depicts an exemplary dashboard of the online rental property management system, according to an aspect of the present disclosure.

FIG. 9 depicts a webpage facilitating entry of a profile for a landlord, according to an aspect of the present disclosure.

FIG. 10 illustrates the entry of a rental property listing, according to the exemplary embodiment of the present disclosure.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that online rental property management system or module may produce some event or cause some event element to be produced. For example, a webpage may receive data to display in whole or in part to display a valuation estimate to an end user device, the webpage may pull such data from a source other than system (e.g., other servers, intermediaries, etc.), or system may entirely provide the valuation estimate to be produced on the webpage.

“Click,” “touch,” and “tap” are terms that typically may be used interchangeably. For example, on a mobile device, users typically touch or tap the screen to select items or press buttons. On a laptop, smartphone, and/or desktop users typically click with a mouse but may in some implementations use a touch screen or the like interface.

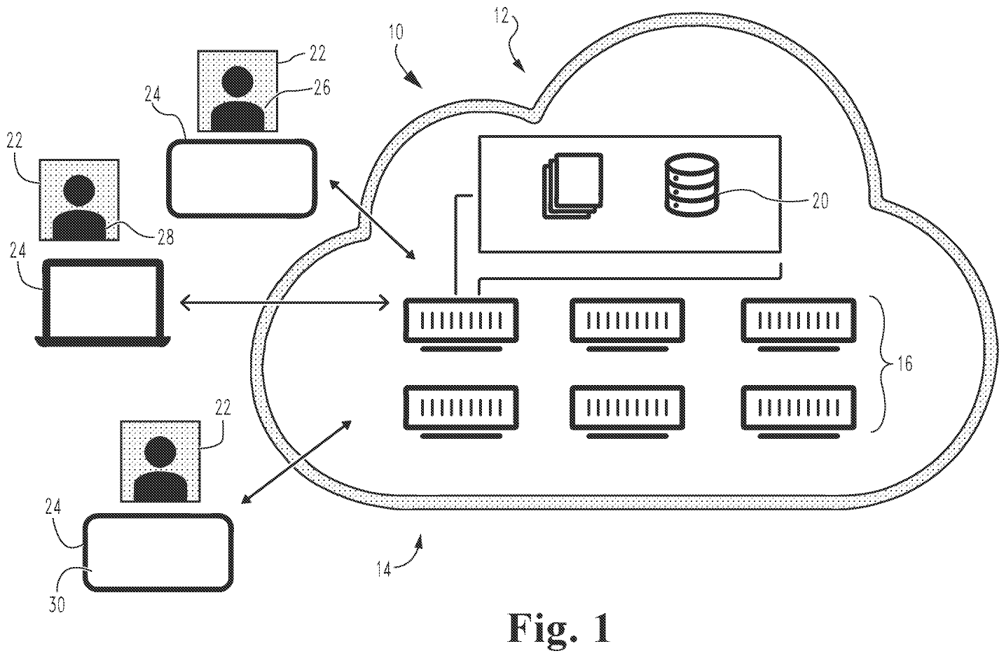

FIG. 1 is a block diagram 10 of an exemplary environment in which the online system for online rental property management 12 of the present disclosure may operate. The exemplary environment, which may or may not utilize “the cloud” 14, may include a plurality of servers 16, along with software 18 and databases 20 capable of running on the servers 16. Software and/or applications 18 implementing the online rental property management system 12 of the present disclosure may be hosted on one or more of the servers 16.

The online rental property management system 12 may be implemented using a variety of different digital environments and should not be limited to the exemplary embodiment that is provided. For example, the online rental property management system 12 may be a web based application or may be a cloud based application. Further, major components of a digital environment may include websites, cloud servers, search engines, social media outlets, mobile apps, audio and video, and other web-based resources, to name a few.

Various users 22, using any one of a variety of different user devices 24, may access the online rental property management system 12 as described herein, such as, for example, via the Internet. Exemplary user devices 24 may include desktop computers, mobile phones, tablets, smart TVs, etc. With specific reference to the online rental property management system 12, types of users 22 may generally include, for example, prospective tenants 26, landlords 28, and third parties 30. Additional and/or alternative users 22 may also use the online rental property management system 12 with respect to any of a variety of different functionalities and/or services offered by the online rental property management system 12.

The one or more databases 20 may be used to store a variety of information needed for operating the online rental property management system 12, including, for example, user accounts and profiles, profile settings, user preferences, rental property listings, subscription information, and various other information that may or may not be unique to the online rental property management system 12. Types of information that may be stored may include images, text, media files, etc.

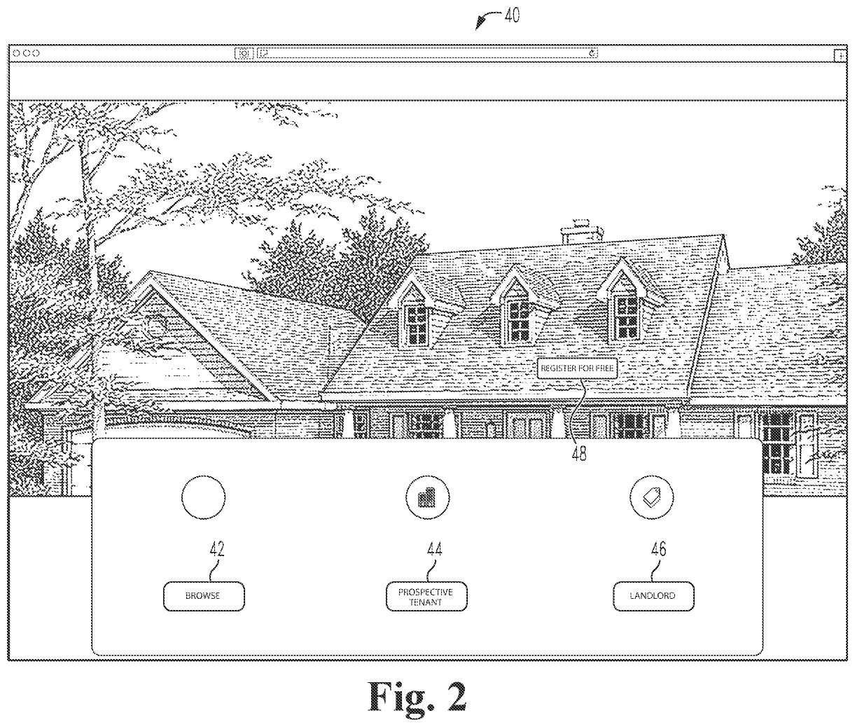

FIG. 2 depicts an exemplary webpage 40, or, in this case, a homepage, of a website by which users 22 may access the online rental property management system 12. The webpage 40 may include information regarding the online rental property management system 12 and may also include links for navigating to additional content and/or functionality on other webpages that are external to or internal to the online rental property management system 12. According to one exemplary use, users 22 may access the webpage 40 and search for rental properties in the online rental property management system 12, such as by tapping a browse button 42. It should be noted that the option for browsing available rental properties through the online rental property management system 12 may be available to any user 22 that visits the site, regardless of the registration status of the user 22.

Users 22 may register as prospective tenants 26 or landlords 28 for additional services of the online rental management system 12 via the webpage 40, such as, for example, by tapping a prospective tenant button 44 or a landlord button 46, to navigate to a different webpage. The additional functionality, or services, may include, among others, matching prospective tenants 26 with landlords 28 and rental properties, facilitating rental application processing, and accommodating direct communications and negotiations between the prospective tenant 26 and landlord 28.

A button 48 to contact system management or other designated persons may also be provided on the webpage 40 for users to get more information. The information may pertain to technical issues with regard to the website and/or issues regarding the online rental property management system 12. Other functionalities and features are contemplated and may be incorporated into the online rental property management system 12.

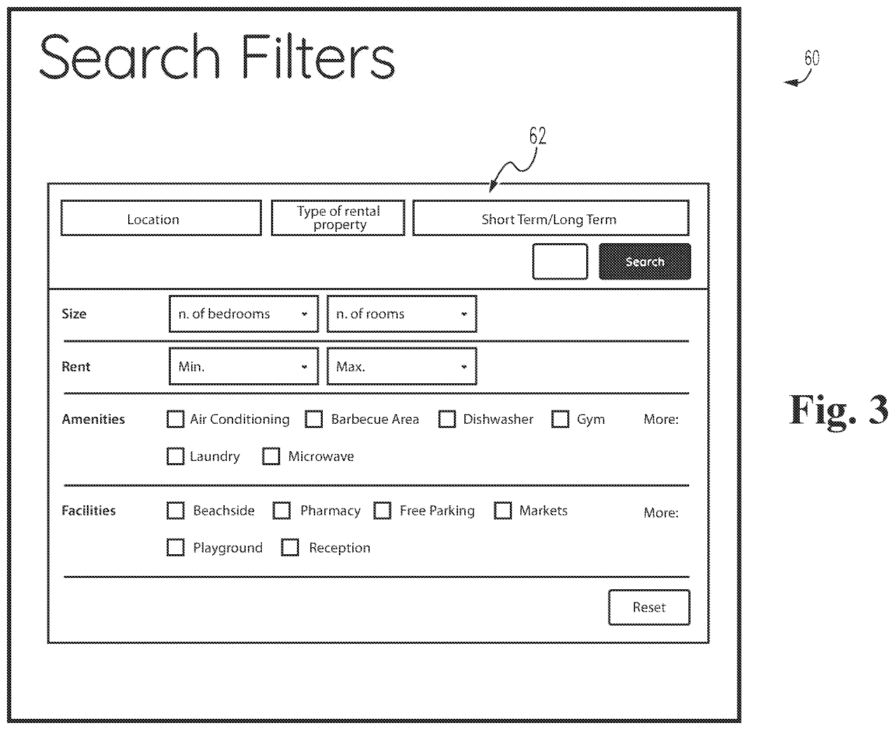

FIG. 3 depicts a webpage 60 facilitating entry of search criteria for locating a rental property, according to an aspect of the present disclosure. For example, a user 22 may be routed to the depicted search criteria filter 62 to aid in identifying rental properties that may be desirable to the user 22. However, a user 22 may browse rental property listings of the online rental property management system 12 with or without any criteria.

Criteria may include, for example, location or area, type of rental property (e.g., room, condo, house, apartment, or other), minimum or maximum rent, whether the lease is short term or long term, whether pets are allowed, number of bedrooms and bathrooms desired, square footage, whether the housing is restricted income, senior living, or student housing, etc. Additional and alternative criteria may also be included.

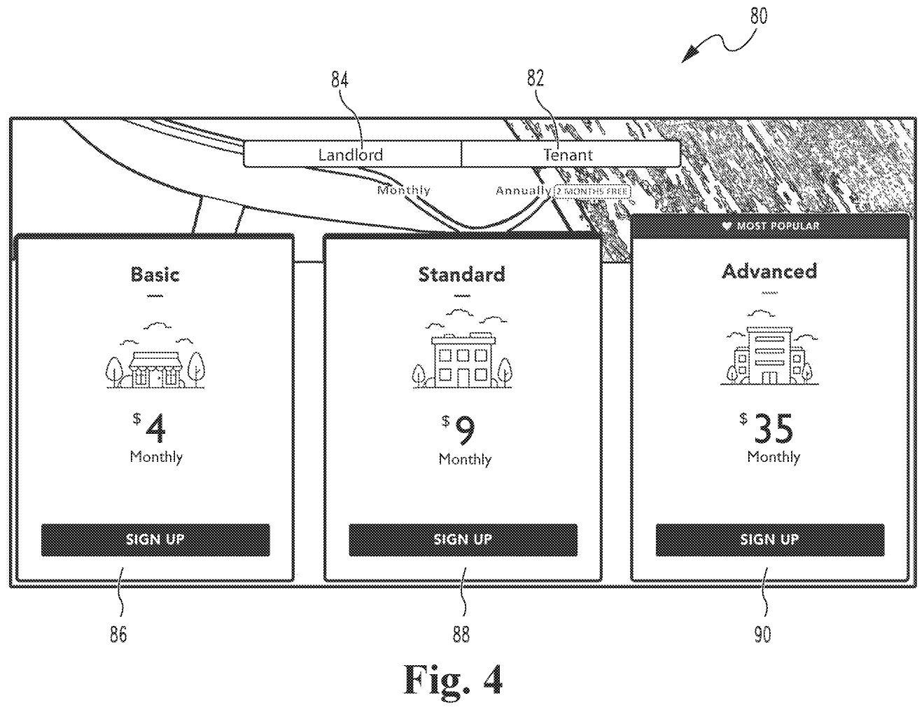

FIG. 4 depicts a webpage 80 presenting different subscriptions available for prospective tenants 26 and landlords 28, The subscriptions include different services of the online rental property management system 12 and may include different durations and different costs. According to the exemplary page, the user 22 may tap or toggle between “prospective tenants” selection 82 or “landlords” selection 84 to view the relevant subscription options available. Different tiers 86, 88, and 90 may offer multiple packages with different features and product combinations available at different price points.

According to the exemplary embodiment, which pertains to subscriptions available for a prospective tenant 26, a first tier 86 for a prospective tenant 26 may be assigned a particular value, or cost, and may offer the ability to submit a rental property application for up to a set number of properties. The first tier 86 may also permit a prospective tenant 26 to “like” up to a set number of properties.

A second tier 88, for example, may offer the ability to submit a rental application for up to a set number of properties that is greater than the set number of properties offered in the second tier. An increased number of “likes” may also be available according to the second tier subscription, with cost of the subscription being increased relative to the first tier 86.

A third tier 90, in accordance with the present disclosure, may allow the prospective tenant 26 to apply for a number of rental properties that is greater than the number of rental properties of the second tier 88. The number of “likes” available as a part of the subscription cost, associated with the third tier 90, may be determined based on the tier selection.

The number of different subscriptions and/or tiers 86, 88, and 90 available to prospective tenants 26, and landlords 28, may vary in content and cost, depending on the particular implementation. Although a particular price model is described, any of a number of different pricing strategies may be used, depending on the particular embodiment.

A landlord 28 may select a subscription tier, similar to the tiers above, based on services unique to the landlord 28. For example, a first tier for a landlord 28 may be assigned a particular cost and may provide the landlord 28 the ability to see prospective tenants 26 that have submitted applications for a rental property of the landlord 28. According to some embodiments, and with respect to the first tier, the landlord 28 may see profiles of prospective tenants 26 that have been pre-approved based on criteria determined by property criteria and requirements of the landlord 28.

A second tier subscription option for the landlord 28 may include the functionality of the first tier plus the ability to invite one or more prospective tenants 26 that “liked” the rental property to apply, with or without an automatic approval. For an automatic approval, the prospective tenant 26 will have been preapproved based on property criteria and requirements.

An exemplary third tier subscription may include the options of the first tier and the second tier and may also include an ability of the landlord 28 to view open profiles of prospective tenants 26, regardless of whether or not the prospective tenant 26 meets the criteria for the rental property. Since the landlord 28 is able to view the profiles of the prospective tenants 26 and the criteria of rental property the prospective tenant 26 is looking for, the landlord 28 is able to be flexible with regard to initial requirements and criteria and, as a result, make a match that otherwise might not have occurred.

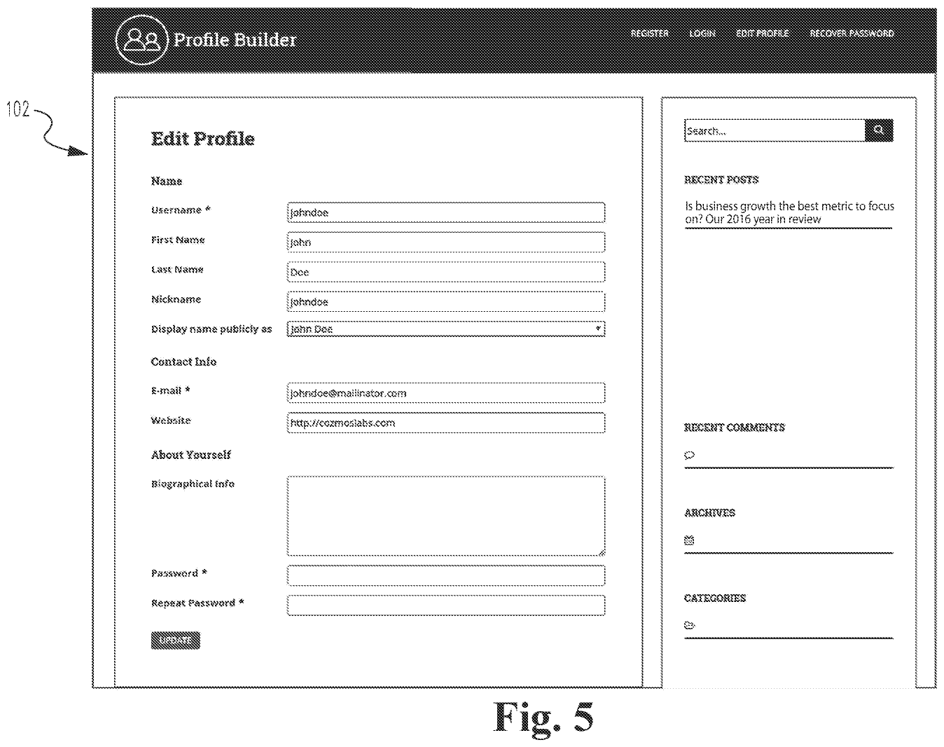

FIG. 5 depicts a webpage 100 facilitating entry of a profile 102 for a prospective tenant 26, according to an aspect of the present disclosure. Exemplary profile information may include basic personal/biographical information about the prospective tenant, including, for example, identification information, such as full name, city/town, phone number, email address, etc.

Profile information may also include information regarding what the prospective tenant 26 is looking for in a rental property. For example, exemplary criteria may include desirable location(s) or area(s), type of rental property (e.g., room, condo, house, apartment, or other), minimum or maximum rent, whether the lease is short term or long term, whether pets are allowed, number of bedrooms and bathrooms desired, square footage, and/or whether the housing is restricted income, senior living, or student housing.

Further, the profile 102 may include additional information that may be required on or with a rental property application, such as, for example, job verification information, paycheck stubs, credit history, criminal history, etc. The prospective tenant 26 may be required to sign a release of information so that some of the information can be acquired and/or verified. Information provided directly from the prospective tenant 26 may be uploaded to one or more databases 20 of the online rental property management system 12.

Some or all of the information provided above may be verified by a third party 30. That is, a third party 30 may independently verify documents and information to verify the authenticity of what the prospective tenant 26 has provided.

The prospective tenant 26 may choose to have an open profile or a closed profile. A prospective tenant 26 having an open profile will permit landlords 28 to invite the prospective tenant 26 to apply to a rental property of the landlord 28, with or without automatic approval, even if the prospective tenant 26 might not have met requirements needed for approval otherwise.

To combat discrimination, and in compliance with the Fair Housing Act, certain personally identifiable information may not be disclosed during the searching and application processes. Some personally identifiable information may include, for example, information regarding race, color, national origin, religion, sex, familial status, and disability.

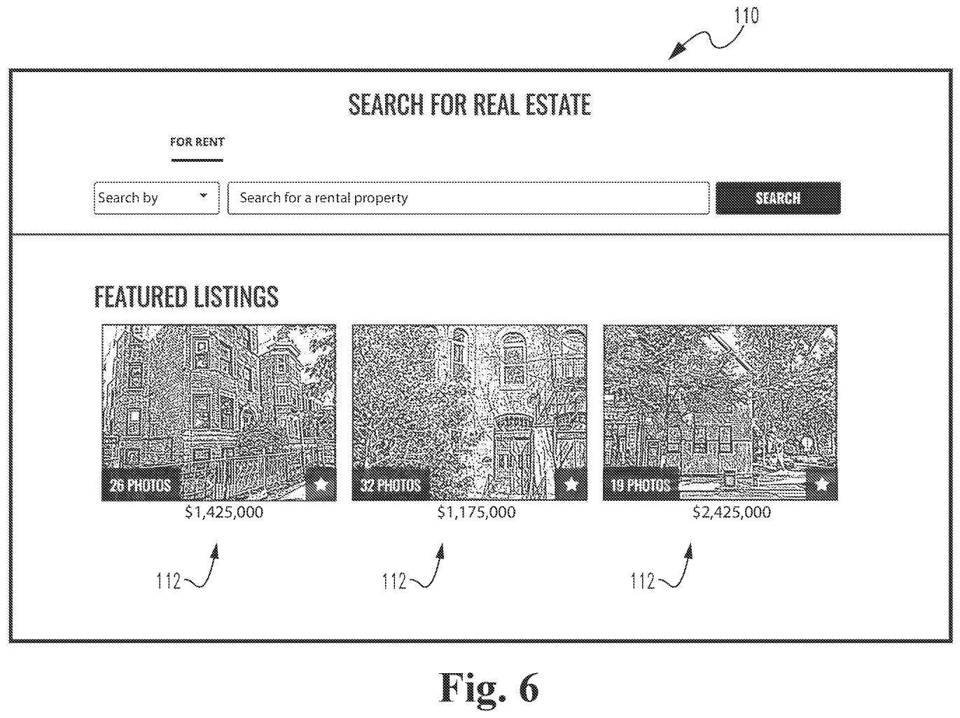

FIG. 6 depicts a webpage 110 illustrating search results 112 according to the exemplary online rental property management system 12. Search results 112 may be based on criteria entered by the prospective tenant 26 and/or may include rental properties that meet prospective tenant's preferences and/or for which automatic approval, based on landlord requirements, may be received.

Search results 112 may be displayed in a manner selected by the prospective tenants 26. For example, the layout, appearance, and order of the search results 112 may be selected by the prospective tenants 26. Various settings, including how the search results 112 are displayed, may have default settings and/or may be customized by a designated user 22.

Listings for rental properties the prospective tenant is pre-approved for may be grouped, or treated, independently relative to other rental property listings. As stated throughout, the prospective tenant 26 will be able to apply for and like a set number of rental properties, according to the selected subscription. Modifying a subscription or adding to a current subscription may also be option.

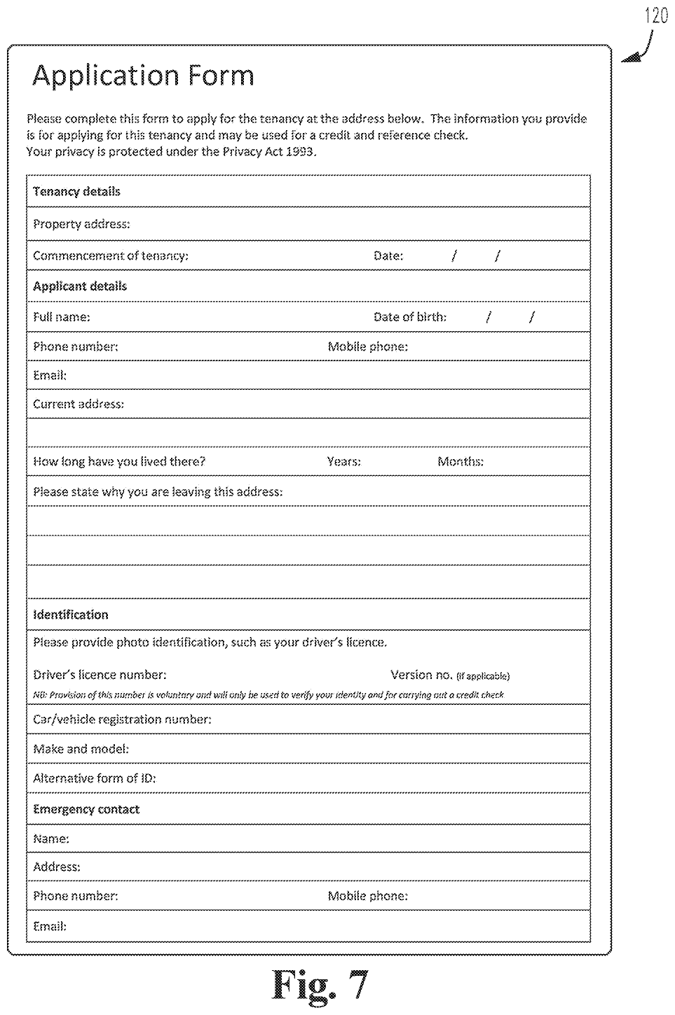

FIG. 7 depicts an exemplary online application form 120 for a prospective tenant 26, according to an aspect of the present disclosure. An application form 120 may include standard information that is typically collected on an apartment application. The application form 120 may also include information described above with respect to the profile information of the prospective tenant 26.

Exemplary information may include biographical information, application fee, photo ID and social security card, credit history, rental history, income guidelines, immediate disqualifications, roommates, pets, and renter's insurance. Collected information may also include disclosure of evictions, public records, current and former landlord references, and verification of income.

As stated above, the online rental property management system 12 facilitates application by the prospective tenant 26 to a plurality of rental properties for a fixed rate. The application information submitted to one application may be stored and transferred to a later application, saving the prospective tenant 26 time and money.

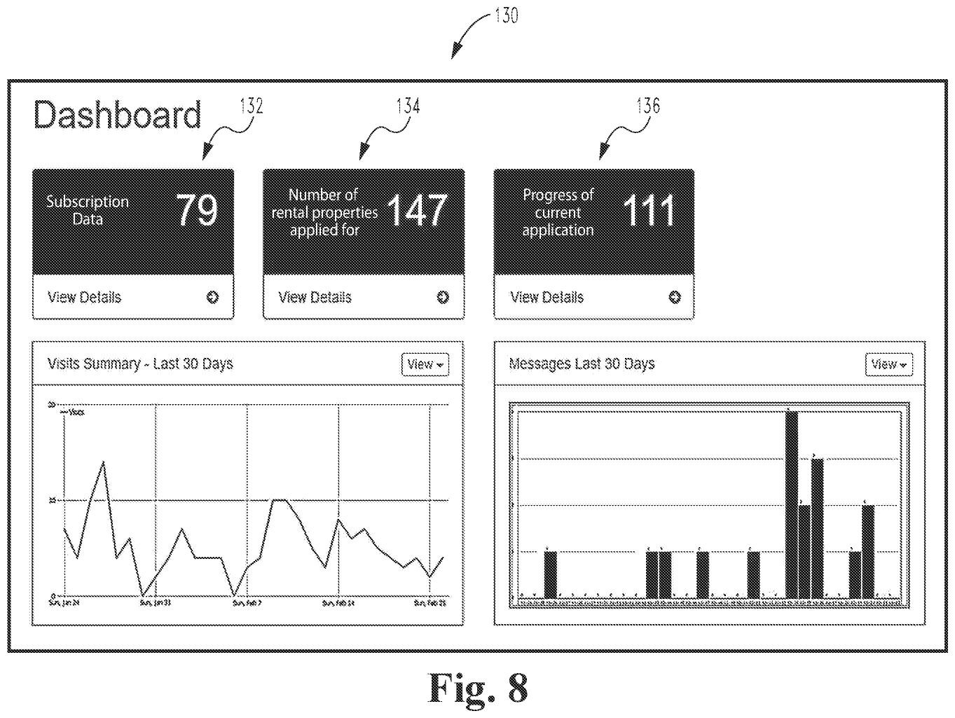

FIG. 8 depicts an exemplary dashboard 130 of the online rental property management system 12, according to an aspect of the present disclosure. From a view of the prospective tenant 26, and referring to FIG. 8, the dashboard 130 may include data, such as, for example, subscription data. Subscription data may include the amount of time remaining on the subscription and the number of application submissions and likes that are remaining with reference to the subscription. The dashboard 130 may also include a section 134 that displays data regarding the number of rental properties the prospective tenant 26 has applied for and a section that displays the number of rental properties the prospective tenant 26 has liked. Further, the dashboard 130 may include a section 136 that provides data that tracks the progress of a current application.

The landlord 28 may also have a dashboard that includes data, such as, for example, subscription data. Subscription data may include the amount of time remaining on a subscription and the current status of available features relating to the subscription. The dashboard may also display information relating to rental property listings, viewing or processing applications submitted by prospective tenants 26, and prospective tenants 26 that have been pre-approved based on various criteria.

The dashboard may also include data regarding prospective tenants 26 that “liked” the rental property, prospective tenants 26 who have open profiles, and various other useful data. Both the prospective tenant 26 and the landlord 28 may benefit from having a dashboard to organize, view, and analyze data relating to the specific roles of the user 22. Additional and/or alternative data may be presented to the prospective tenant 26 and the landlord 28 without deviating from the scope of the disclosure.

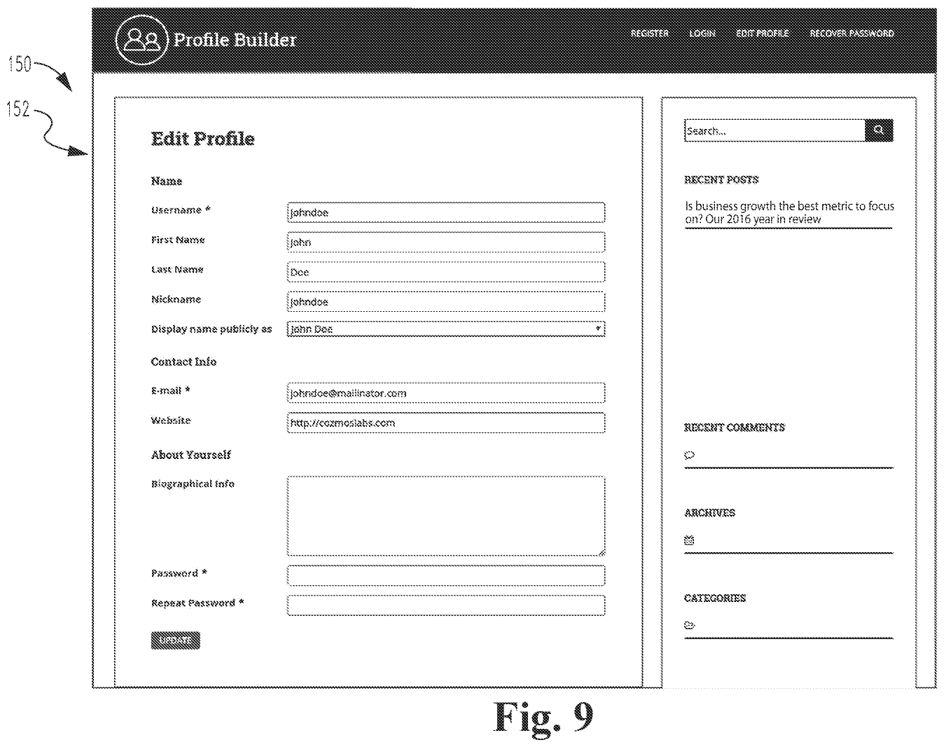

FIG. 9 depicts a webpage 150 facilitating entry of a profile 152 for a landlord 28, according to an aspect of the present disclosure. Exemplary profile information may include biographical information, including, for example, identification information, such as full name, city/town, phone number, email address, etc. The profile 152 may also include credentials of the landlord 28, geographical areas where the landlord 28 has rental properties, and various other information.

Some or all of the information provided above may be verified by a third party 30. That is, a third party 30 may independently verify documents and information to verify the authenticity of what the landlord 28 has provided.

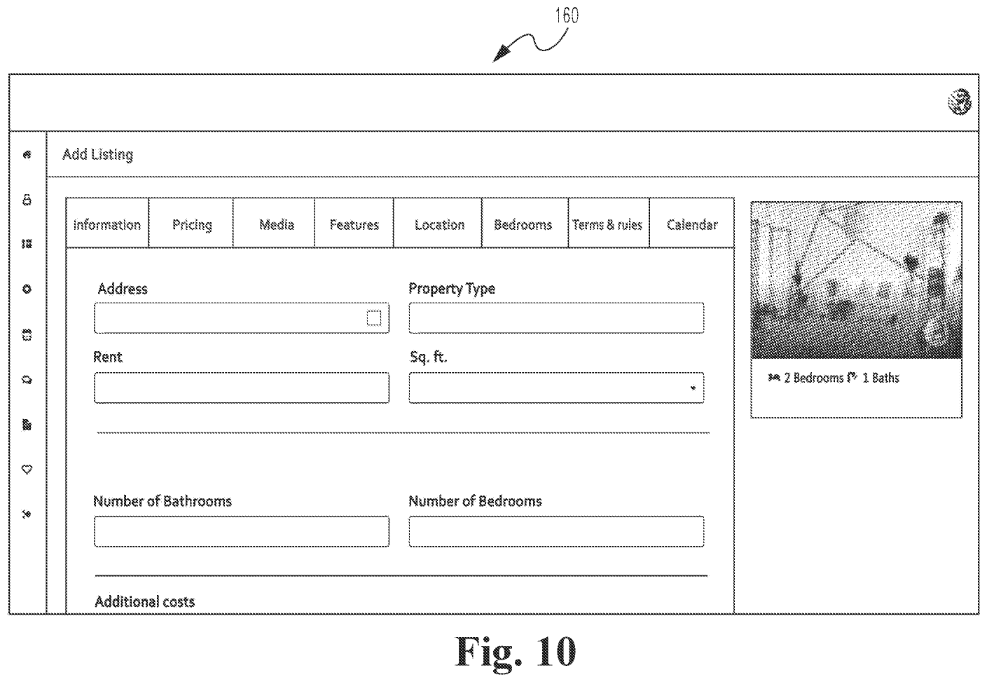

FIG. 10 depicts a rental property listing 160 according to the exemplary embodiment of the present disclosure. Information of the rental property listing 160 may include address, property type, rent, area, Sqft., bedrooms, bathrooms, etc.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for online rental property management using an online rental property management system, wherein the online rental property management system includes at least hardware, software, applications, and data storage, the method including steps of:
storing in the data storage at least one prospective tenant profile, a rental property listing, and a landlord profile linked to the rental property listing, wherein the prospective tenant profile includes at least tenant personal information, a rental property description, a rental background check, and a credit check;
vetting at least a portion of information in the prospective tenant profile by a third party;
selecting a subscription by a prospective tenant, wherein the subscription includes at least a payment of a predetermined fee corresponding to a plurality of different rental applications using the system;
comparing the rental property description of the prospective tenant profile to one or more rental property listings in the data storage using the system;
identifying, by the system, selected rental property listings that at least partially match the rental property description of the prospective tenant profile; and
based on the comparing step and the identifying step, designating the prospective tenant, with respect to the selected rental property listings, as approved or not approved using the system.

2. The method of claim 1, further including reviewing the prospective tenant profile corresponding to one of the selected rental property listings; and the landlord designating the prospective tenant, with respect to the selected rental property listing, as approved or not approved.

3. The method of claim 1, wherein approval of the prospective tenant is automatically generated using the system when the selected rental property listing at least partially matches the rental property description of the prospective tenant profile.

4. The method of claim 1, wherein the landlord, using the system, invites the prospective tenant to apply for a rental property and receive automatic approval.

5. The method of claim 1, wherein the landlord, using the system, invites the prospective tenant that is designated as not approved to reapply.

6. The method of claim 1, further including vetting at least a portion of information in the landlord profile by the third party.

7. The method of claim 1, wherein the landlord accesses the tenant personal information of the prospective tenant profile for the prospective tenant matched to a rental property listing that is associated with the landlord.

8. The method of claim 1, wherein payment of a security deposit is transmitted electronically from the prospective tenant to the landlord

9. The method of claim 1, wherein a lease agreement between the prospective tenant and the landlord is executed electronically using the system.

10. The method of claim 1, wherein the system is implemented using cloud based computing.

11. A method for online rental property management using an online rental property management system, wherein the online rental property management system includes at least hardware, software, applications, and data storage, the method including steps of:
storing in the data storage at least one prospective tenant profile, a rental property listing, and a landlord profile linked to the rental property listing, wherein the prospective tenant profile includes at least tenant personal information, a rental property description, a rental background check, a credit check, and a rental verification;
ret ng at least a portion of information in the tenant profile by a third party;
comparing the rental property description of the prospective tenant profile to one or more rental property listings in the data storage using the system;
identifying, by the system, selected rental property listings that at least partially match the rental property description of the prospective tenant profile;
designating the prospective tenant, with respect to the selected rental property listings, as approved or not approved using the system; and
inviting, by the landlord, a prospective tenant to apply.

12. The method of claim 11, inviting, by the landlord, a prospective tenant designated as not approved to reapply.

13. The method of claim 11, wherein the landlord, using the system, invites the prospective tenant to apply for a rental property and receive automatic approval.

14. The method of claim 11, further including reviewing the prospective tenant profile corresponding to one of the selected rental property listings; and the landlord signaling the prospective tenant, with respect to the selected rental property listing, as approved or not approved.

15. The method of claim 11, further including vetting at least a portion of information in the landlord profile by a third party.

16. An online rental property management system, including:
an electronic system including at least hardware, software, applications, and data storage;
the data storage including at least one prospective tenant profile, a rental property listing, and a landlord profile linked to the rental property listing, wherein the prospective tenant profile includes at least tenant personal information, a rental property description, a rental background check, and a credit check;
a third party accessing the system and vetting at least a portion of information in the prospective tenant profile;
the system receiving a selection of a subscription by a prospective tenant, wherein the subscription includes at least a payment of a predetermined fee corresponding to a plurality of different rental applications using the system;
the system receiving and storing submission of an application by the prospective tenant;
the system comparing the rental property description of the prospective tenant profile to one or more rental property listings in the data storage;
the system identifying selected rental property listings that at least: partially match the rental property description of the prospective tenant profile; and
the system designating the prospective tenant, with respect to the selected rental property listings, as approved or not approved using the system.

17. The method of claim 16, inviting, by the landlord, the prospective tenant designated as not approved to reapply.

18. The method of claim 16, wherein the landlord, using the system, invites the prospective tenant to apply for a rental property and receive automatic approval.
